(19) United States
(12) Patent Application Publication
(10) Pub. No.: US 2021/0189121 A1
(43) Pub. Date: Jun. 24, 2021

(54) PROCESS FOR THE PREPARATION OF A POLYURETHANE FOAM

(71) Applicant: SOLVAY SA, Brussels (BE)

(72) Inventors: Joo-Hee KANG, Mapo-gu, Seoul (KR); Ferdinand HARDINGHAUS, Bad Honnef (DE); Karsten BÖRNER, Sehnde (DE); Jean FABRE, Wettbergen (DE)

(21) Appl. No.: 16/077,824

(22) PCT Filed: Feb. 24, 2017
(86) PCT No.: PCT/EP2017/054302

§ 371 Date: Aug. 14, 2018

(30) Foreign Application Priority Data
Feb. 26, 2016 (EP) 16157615.2

(51) Int. Cl. C08L 75/04; C08K 3/26; C08J 9/04; C08G 18/42; C08G 18/48

(52) U.S. Cl. CPC C08L 75/04; C08K 3/26; C08J 9/04; C08J 2201/022; C08G 18/4829; C08G 2110/0025; C08G 18/4211

(57) ABSTRACT

The present invention relates to processes for the preparation of polyurethane foams comprising a step wherein a chemical compound with a low particle size releases a chemical and/or physical blowing agent by decomposition, polyurethane foams prepared by such processes as well as compositions comprising at least one polyol and a chemical compound with a low particle size capable of releasing a chemical and/or physical blowing agent by thermally- and/or chemically-induced degradation and uses of such compositions.

The present invention relates to processes for the preparation of polyurethane foams comprising a step wherein a chemical compound with a low particle size releases a chemical and/or physical blowing agent by decomposition, polyurethane foams prepared by such processes as well as compositions comprising at least one polyol and a chemical compound with a low particle size capable of releasing a chemical and/or physical blowing agent by thermally- and/or chemically-induced degradation and uses of such compositions.

Polyurethane foams can be prepared by reacting an appropriate polyisocyanate with a mixture of isocyanate-reactive compounds, usually polyols, in the presence of a blowing agent. Such foams are often used as thermal insulation medium. These thermal insulating properties are dependent upon a number of factors including the cell size. Thermally insulating foams with small cell sizes have been suggested in the prior art. Theoretically, small cell sizes in the nanometer range should lead to superior insulation properties since the contribution of the gas to the thermal conductivity can be reduced (‘Knudsen effect’). To this end, U.S. Pat. No. 9,139,683B2 suggests the use of supercritical or near-critical CO₂ as blowing agent. However, the handling of supercritical or near-critical is not straight-forward and could pose a risk to occupational safety.

Now therefore, the invention makes available improved polyurethane or modified polyurethane foams as well as improved processes for the preparation of (modified) polyurethane foams. It is an objective of the present invention to provide a process which is safer, more economical and/or more ecological. Furthermore, it is an objective of the present invention to provide a process which leads to polyurethane foams with improved stability, flammability, thermal insulation properties, processability, and/or cell size.

This objective and other objectives are achieved by the invention as outlined in the patent claims.

Accordingly, one aspect of the present invention concerns a process for the preparation of a polyurethane foam or a modified polyurethane foam comprising a step wherein a chemical compound releases a chemical and/or physical blowing agent by thermally- and/or chemically-induced decomposition wherein the chemical compound has a particle size distribution expressed as a D50 of equal to or less than 1 μm, preferably equal or below 500 nm, more preferably equal to or below 250 nm.

Polyurethane foams are generally prepared by contacting two separate compositions. On the one hand, the so-called B-side, which generally consists of isocyanates or mixtures of isocyanates. On the other hand, the so-called A-side comprises all other components used in the production of the foam, notably the polyols or mixtures polyols. This definition of the A-side and the B-side is widely followed in Europe and is also used herein. The A-side usually also comprises the blowing agents, flame retardants, catalysts, surfactants and other auxiliary agents. In a preferred embodiment the polyurethane foam is prepared by spray foaming. Spray foaming means that A-side and B-side are joined under pressure in a spray nozzle and afterwards are applied directly onto the space where the insulation is required, e.g. a wall, roof or building assembly.

Blowing agents are chemical compounds which are capable of producing a cellular structure or matrix during the polyurethane foam formation.

Chemical blowing agents are known in the art. The term “chemical blowing agent” is intended to denote a blowing agent which chemically reacts with at least one of the components of the compositions used in the foam blowing process. Most specifically, water can be used as a chemical blowing agent as it forms CO₂ in the reaction with an isocyanate. The CO₂ thus formed is used to create the cellular structure in the foam. For the avoidance of doubt, the term “chemical blowing agent” as used herein is intended to mean a chemical blowing agent which is formed in the decomposition reaction of the chemical compound.

Physical blowing agents are also known in the art. The term “physical blowing agent” is intended to denote a blowing agent which generally does not react chemically with one of the components of the compositions used in the foam blowing process. Suitable physical blowing agents include carbon dioxide, carbon monoxide, nitrogen, and hydrogen. Specifically, carbon dioxide is used as a physical blowing agent. For the avoidance of doubt, the term “physical blowing agent” as used herein is intended to mean a physical blowing agent which is formed in the decomposition reaction of the chemical compound.

The term “polyurethane foam” is intended to denote polymers resulting essentially from the reaction of polyols with isocyanates. These polymers are typically obtained from formulations exhibiting an isocyanate index number from 100 to 180. The term “modified polyurethane foam” is intended to denote polymers resulting from the reaction of polyols with isocyanates that contain, in addition to urethane functional groups, other types of functional groups, in particular triisocyanuric rings formed by trimerization of isocyanates. These modified polyurethanes are normally known as polyisocyanurates (PIR). These polymers are typically obtained from formulations exhibiting an isocyanate index number from 180 to 550.

Preferably, the polyurethane and the modified polyurethane foam is a rigid, closed-cell foam.

Any isocyanate conventionally used to manufacture such foams can be used in the process according to the invention. Mention may be made, for example, of aliphatic isocyanates, such as hexamethylene diisocyanate, and aromatic isocyanates, such as tolylene diisocyanate or diphenylmethane diisocyanate.

Any polyol conventionally used to manufacture such foams can be used in the process according to the invention. The term “polyol” is intended to denote a compound containing more than one hydroxyl group in the structure, e.g. the compound may contain 2, 3, or 4 hydroxyl groups, also preferably 5 or 6 hydroxyl groups, and is intended to comprise a polyol of a single defined chemical structure as well as a mixture of polyols of different chemical structures. Preferred are synthetic polyols. Also preferred are polymeric polyols, more preferably polyester or polyether polyols. Suitable examples for polyester polyols include polycaprolactone diol and diethylene glycol terephthalate. Suitable examples of polyether polyols include polyethylene glycol, e.g. PEG 400, polypropylene glycol and poly(tetramethylene ether) glycol. Also preferred are polyetherpolyols based on carbohydrates, glycerine or amines. Examples for suitable carbohydrate bases include sucrose and sorbitol. Most preferred are brominated polyether glycols, e.g. polyetherpolyol B 350 (CAS-No.: 68441-62-3). Especially suitable is the mixture of polyetherpolyol B 350 and triethyl phosphate, which can be obtained under the brand name IXOL® B 251 from Solvay.

Optionally, at least one further component selected from a flame retardant, a foam stabilizer, a catalyst, a surfactant and a co-blowing agent can be added to the B-side or preferably, to the A-Side.

The co-blowing agent can be selected from the chemical and/or physical blowing agents as described above.

“Chemical co-blowing agent” as used in this invention is intended to denote a component comprised in the A-side which can react with the isocyanate of the B-side. It is believed that the energy released from this reaction in form of heat is accelerating the further foam producing process. Preferable chemical co-blowing agents include water, NH₃, primary amines, secondary amines, alcohols, preferably difunctional or trifunctional alcohols; hydroxylamine, and aminoalcohols. Especially preferred are bifunctional or multifunctional amines, glycols or glycerols. Suitable examples include diaminoethane, 1,3-diaminopropane and triethanolamine.

Preferable physical co-blowing agents comprise alkanes, e.g. propane or cyclopropane, fluorinated alkanes (HFCs) as well as fluorinated alkenes (HFOs). Regarding HFCs and HFOs, mention may be made, for example, of 1,1,1,3,3-pentafluorobutane (HFC 365mfc), 1,1,1,2-tetrafluoroethane (HFC-134a), 1,1,1,2,3,3,3-heptafluoropropane (HFC 227ea), 1,1,1,3,3-pentafluorpropane (HFC 245fa), halogenated olefins like HFO-1234yf, HFO-1234zr and HFO-1233zd, or mixtures of said alkanes and alkenes.

In case a co-blowing agent is used, it is preferably used in a range of 1 to 20 wt %, more preferably 2 to 10 wt %, most preferably 3 to 7 wt %, based on the total weight of the A-side.

Any flame retardant conventionally used in the manufacture of such foams can be used. Mention may be made, for example, of flame retardants based on phosphorous esters. Suitable examples include triethylphosphat (TEP), tris(2-chlorisopropyl)phosphate (TCPP), dimethylpropane phosphonate (DMPP), diethylethane phosphonate (DEEP)triethyl phosphate, trischloroisopropyl phosphate. In practice, the amount of flame retardant used generally varies from approximately 0.05 to 50 parts by weight per 100 parts by weight of polyol, preferably 1 to 25, more preferably 10 to 20.

Suitable catalysts include compounds that catalyze the formation of the —NH—CO—O— urethane bond by reaction between a polyol and an isocyanate or that activate the reaction between an isocyanate and water, such as tertiary amines and organic tin, iron, mercury or lead compounds. Mention may in particular by made, as tertiary amines, of triethylamine, N,N-dimethylcyclohexylamine, N-methylmorpholine, N-ethylmorpholine, dimethylethanolamine, diaza[2.2.2]bicyclooctane (triethylenediamine) and substituted benzylamines, such as N,N-dimethylbenzylamine, and N,N,N′,N″,N″-pentamethyldiethylenetriamine (PMDTA). Mention may in particular be made, as organic tin or lead compounds, of dibutyltin dilaurate, stannous octanoate and lead octanoate. Other suitable catalysts intended for the manufacture of modified polyurethane (polyisocyanurate) foams include compounds that catalyse the trimerization of isocyanates to triisocyanurates.

In practice, the amount of catalyst used generally varies from approximately 0.05 to 10 parts by weight per 100 parts by weight of polyol. In general, the amount of the composition according to the invention is from 1 to 80 parts by weight per 100 parts by weight of polyol. It is preferably from 10 to 60 parts by weight per 100 parts by weight of polyol.

Any foam stabilizer conventionally used in the manufacture of such foams can be used. Mention may be made, for example, of siloxane polyether copolymers. In practice, the amount of foam stabilizer used generally varies from approximately 0.05 to 10 parts by weight per 100 parts by weight of polyol, preferably 0.5 to 3.0, more preferably 1 to 2.

The term “thermally-induced decomposition” is intended to denote the decomposition of the chemical compound which is mainly affected by exposing the chemical compound to an elevated temperature. Preferably, the elevated temperature is a result of the exothermic chemical reactions involved in the formation of the foam, e.g. a result of the reaction of an isocyanate with a polyol. Also preferably, the elevated temperature is supplied by an external energy source, more preferably by pre-heating any or all of the components of the A- or B-side or of the equipment used in the foaming process. “Elevated temperature” is intended to denote a temperature which is above ambient temperature. Suitable temperatures are from 30 to 100° C., preferably from 40 to 90° C., more preferably from 50 to 80° C. A specific example of a thermally-induced decomposition is the decomposition of sodium bicarbonate (NaHCO₃). In this case, the elevated temperature is above the decomposition temperature of sodium bicarbonate, which is 50° C.

Preferably, the chemical compound releases the chemical and/or physical blowing agent by thermally-induced decomposition. More preferably the chemical compound releases the chemical and/or physical blowing agent by thermally-induced decomposition in the absence of an acidic activator. In a preferred embodiment, the A-side or the B-side or both A-side and B-side may be pre-heated before the production of the foam. They may be pre-heated to a temperature of from 25° C. to about 80° C., preferably from 30° C. to 60° C., more preferably from 40 to 50° C. Said pre-heating step may be conducted in the storage tank containing the A- and/or B-side. It may also be conducted in the lines from the storage tank to the point of mixing the A- and B-side. Said mixing is conventionally conducted using a mixing head. Alternatively, the mixing head itself may be heated to pre-heat the A and/or B-side immediately before the mixing step. If the foam production is performed by a spray foaming process the spray nozzle itself may be heated.

The term “chemically-induced decomposition” is intended to denote a decomposition of the chemical compound which is mainly affected by the chemical reaction of the chemical compound with an activator, preferably with a basic or acidic activator. Suitable acidic activators include Brønsted acids, for example carboxylic acids, specifically citric acid, acidic acid and formic acid. Also preferably, the acidic activator can be formed in situ during the foaming process. A suitable example is acetic acid which can be formed in situ from acidic anhydride by reaction with water. In a more preferred embodiment, NaHCO₃ is used in combination with acidic anhydride.

Preferably, the chemical compound releases the chemical and/or physical blowing agent by chemically-induced decomposition, more preferably in the presence of an acidic activator, most preferably in the presence of citric acid, acetic acid, polyphosphoric acid and/or formic acid. Also preferably, the acid activator is a dicarboxylic acid, e.g. oxalic acid, malonic acid, succinic acid, glutaric acid or adipic acid. The acid activator is preferably comprised in the A-side. In another preferred embodiment for spray foaming, the acid activator is added via a third line to the spraying nozzle simultaneously during the spray foaming process.

Also preferably, the chemical compound releases both a chemical and a physical blowing agent. More preferably, the chemical compound releases both a chemical and a physical blowing agent by thermally-induced decomposition.

Preferably, the chemical compound is an inorganic carbonate. Suitable inorganic carbonates include NaHCO₃, Na₂CO₃, CaCO₃, (NH₄)₂CO₃, NH₄HCO₃, MgCO₃ and trona. In a specific embodiment of this invention, the chemical compound is NaHCO₃.

Also preferably, the chemical compound is a hydrate of an inorganic salt, more preferably the hydrate of a salt of an alkaline metal or an alkaline earth metal, most preferably the chemical compound is a hydrate of sodium sulphate, specifically Na₂SO₄.10H₂O.

Preferably, the chemical compound has a particle size distribution expressed as a D50 of equal to or above 10 nm, preferably equal to or above 50 nm, more preferably equal to or above 100 nm. Also preferably, the particle size distribution expressed as a D50 is equal to or higher than 1 nm, preferably equal to or higher than 10 nm. More preferable is from 25 to 250 nm, most preferably between 50 and 150 nm. Specifically, from 60 to 100 nm.

The particle size distribution according to the present invention is given as a D50 value meaning that 50% of a sample's mass is comprised of particles smaller than the given value. The particle size distribution can be measured using a Laser Diffraction Particle Size Analyser (Beckmann Coulter® LS 230). The sample is added to the instrument where it is added to an isopropanol medium at room temperature.

Chemical compounds with a particle size distribution in the inventive range are commercially available. Alternatively, they can be prepared, for example by controlled precipitation from suitable starting materials. For example, NaHCO₃ with a suitable particle size distribution can be precipitated from a saturated solution of sodium chloride by addition of ammonium bicarbonate, filtrated and collected.

Chemical compounds with a particle size distribution in the inventive range can also be prepared by reducing the particle size of the chemical compound. Preferably, this reduction in particle size is performed in a mill. A particularly suitable mill is a ball mill, also called planetary mill, bead mill or pearl mill. Thus, a loose solid grinding medium is agitated together with the chemical compound to achieve a milling and/or grinding effect. Suitably, the solid grinding medium comprises hard objects made for example of flint, steel, glass or ceramic, e.g. zirconia. The shape of the grinding medium may vary and can be selected for example from a sphere, an ovoid, a polyhedron, or a torus. A sphere is especially suitable. In case of a sphere, the size of the grinding medium is from 0.01 to 1.00 mm, preferably between 0.03 to 0.10 mm, more preferably around 0.05 mm.

The particle size of the chemical compound can also be reduced by co-milling. Thus, the chemical compound is subjected to a milling step in the presence of co-grinding agent, preferably a co-grinding agent having a greater hardness than the chemical compound. The term “hardness” refers to the hardness according to the Mohs scale. Suitable examples for co-grinding agents include silica, sand, zeolithes, and oxides of metals, preferably alkaline metals or alkaline earth metals, such as CeO₂, ZrO₂, MgO or ZnO. The co-milling can be performed according to the procedures as disclosed in U.S. Pat. No. 5,466,470. The co-milling agent can preferably also be a chemical compound capable of releasing a chemical and/or physical blowing agent. In a suitable example, a mixture of NaHCO₃ and NaSO₄.10H₂O can be co-milled. The co-milling step is most preferably conducted in a ball mill.

Also preferably, the particle size of the chemical compound can be reduced after suspending it in either the B-side or in at least one component of the B-side, e.g. in an isocyanate or a mixture of isocyanates used in the foam blowing process. More preferably, the particle size of the chemical compound can be reduced after suspending it in either the A-side or in at least one component of the A-side, e.g. in at least one polyol used in the foam blowing process. Also preferably, the particle size of the chemical compound can be reduced after suspending it in at least one flame retardant, e.g. in triethyl phosphate and/or trischloroisopropyl phosphate. Accordingly, this more preferred embodiment is a process comprising the steps of

a1) preparing a suspension comprising the chemical compound and at least one polyol or at least one flame retardant or a mixture thereof,

a2) subjecting the suspension formed in step a1) to a treatment to reduce the particle size distribution of the chemical compound, and

b) contacting the suspension formed in step a2) with a composition comprising at least one isocyanate to prepare a polyurethane foam wherein a chemical compound releases a chemical and/or physical blowing agent under thermal and/or chemical activation and wherein the chemical compound has a particle size distribution expressed as a D50 of equal to or less than 1 μm.

Preferably, the treatment to reduce the particle size distribution comprises a milling step, more preferably a milling step using a ball mill.

Also preferably, the treatment to reduce the particle size distribution comprises a sonication treatment step.

Also preferably, the treatment to reduce the particle size distribution comprises a simultaneous milling and sonication treatment step.

In a further preferred embodiment of the process according to the invention, the particle size of the chemical compound, specifically of the NaHCO₃, is reduced by milling in a milling solvent. The term “milling solvent” is intended to denote a solvent in which the chemical compound is subjected to a milling step and which is removed before the chemical compound is used for the foam production. The boiling point of said milling solvent is preferably between 50 and 150° C., more preferably between 60 and 120° C. Examples of suitable milling solvents include alcohols, water, hydrocarbons, hydrofluorocarbons, and chlorinated hydrocarbons. Preferably, the alcohol is ethanol, propanol, isopropanol, isobutanol. Also preferred milling solvents are perfluoropolyethers, especially the Galden® product range from Solvay Fluor GmbH, specifically Galden® HT55.

The concentration of the chemical compound, specifically the NaHCO₃, in the milling solvent is between 10 and 70 wt %, preferably, 20 to 50 wt %, and more preferably between 30 and 40 wt %.

In a preferred embodiment, the milling step is performed in the presence of a surfactant. Not to be bound by a theory, it is believed that the surfactant avoids the agglomeration and/or aggregation of the chemical compound.

“Surfactant” shall denote organic compounds that are amphiphilic, meaning they contain both a hydrophobic group and a hydrophilic group.

Examples of suitable non-ionic surfactants include without limitation linear alcohol ethoxylates, polyoxyethylene alkylphenol ethoxylates, polyoxyethylene alcohol ethoxylates, polyoxyethylene esters of fatty acids, polyoxyethylene alkylamines, alkyl polyglucosides, ethylene oxide-propylene oxide copolymers or a combination thereof.

Examples of suitable cationic surfactants include without limitation quaternary ammonium salts, ethoxylated quaternary ammonium salts, or a combination thereof. A preferred cationic surfactant may have a carbon chain length of 8-20 carbon atoms.

Surfactants having phosphate, carboxylate, sulphonate or sulphate groups as hydrophilic groups are preferred. Also preferred are surfactants having polyether or polyester based side chains as hydrophobic groups are preferred. Preferred polyether based side chains have 3 to 50, preferably 3 to 40, in particular 3 to 30 alkyleneoxygroups. The alkyleneoxygroups are preferably selected from the group consisting of methyleneoxy, ehtyleneoxy, propyleneoxy and butyleneoxy groups. The length of the polyether based side chains is generally from 3 to 100, preferably from 10 to 80 nm.

Suitable examples of such surfactants are represented by phosphoric acid derivatives in which one oxygen atom of the P(O) group is substituted by a C3-C10 alkyl or alkenyl radical.

The surfactant may be, for example, a phosphoric diester having a polyether or polyester based side chain and an alkenyl group moieties. Alkenyl groups with 4 to 12, in particular 4 to 6 carbon atoms are highly suitable. Especially preferred are phosphoric esters with polyether/polyester side chains, phosphoric ester salts with polyether/alkyl side chains and surfactants having a deflocculating effect, based for example on high molecular mass copolymers with groups processing pigment affinity.

The milling solvent is removed after the milling step and a suspension of the chemical compound in the A-side or at least one component of the A-side is prepared, i.e. an exchange of the suspension medium is performed. This exchange can be performed by conventional means, e.g. using a rotary evaporator.

According to this preferred embodiment, the treatment to reduce the particle size distribution comprises the following steps:

m1) preparing a suspension of the chemical compound, specifically NaHCO₃, in a milling solvent,

m2) subjecting the suspension formed in step m1) to a treatment to reduce the particle size distribution of the chemical compound, specifically a milling step,

m3) removing the milling solvent by evaporation and/or filtration

m4) preparing a suspension of the chemical compound, specifically NaHCO₃, formed in step m3) in the A-side or in one or several components of the A-side, and

m5) contacting the suspension formed in step m4) with a composition comprising at least one isocyanate to prepare a polyurethane foam wherein a chemical compound releases a chemical and/or physical blowing agent under thermal and/or chemical activation and wherein the chemical compound has a particle size distribution expressed as a D50 of equal to or less than 1 μm.

Another aspect of the present invention concerns a (modified) polyurethane foam obtainable by the inventive process as outlined above. Preferably, said foam comprises cells with an average cell size measured according to ASTM D 3576 from 10 nm to 1 μm, preferably from 50 nm to 500 nm, more preferably from 100 nm to 250 nm. The polyurethane or modified polyurethane foam according to the invention is preferably a rigid closed-cell foam. The polyurethane or modified polyurethane foam can also be selected from a flexible or semi-flexible foam, e.g. for the production of show soles or for padding of saddles, or integral skin foam.

Preferably, the polyurethane foam or modified polyurethane foam is produced by spray foaming. Also preferably, the inventive process is used to produce discontinuous or continuous panels, tubes for pipe insulation, sandwich panels, laminates and block foams. Also preferably, the inventive foam is used for noise cancellation. Still another aspect of the present invention concerns a composition comprising at least one polyol and a chemical compound capable of releasing a chemical and/or physical blowing agent by thermally- and/or chemically-induced degradation wherein the chemical compound has a particle size distribution expressed as a D50 of equal to or less than 1 μm as well as the use of such compositions in the preparation of a polyurethane or modified polyurethane foam.

The thermal conductivity of the inventive foams can be measured using the norm “EN 12667: Thermal performance of building materials and products” by means of a guarded hot plate and a heat flow meter.

The examples hereafter are intended to illustrate the invention in a non-limitative manner.

### EXAMPLES

### Example 1: Preparation of Polyol Mixture

13.5 wt % NaHCO₃ (Bicar® from Solvay) was dispersed in a polyol mixture comprising 16.7 g IXOL® B251, 50.0 g Stepanol® 2412 and 33.3 g Voranol® RN 490 by using a PENDRAULIK overhead dissolver at 10000 rpm for 30 min. Subsequently, the resulting mixture was subjected to a milling step in a bead mill DISPERMAT® SL-C 25 (manufacturer: VMA-Getzmann GmbH) using ZrO2 beads (diameter: 0.5 mm) at 200 rpm for 12.5 h. Subsequently, the mixture was subjected to a sonication step for 1 h.

The particle size distribution of the NaHCO₃ in the resulting suspension was measured as described above and showed a D50 of 0.85 μm.

Table 1 shows the D50 values achieved with various milling times and optional sonication (1 h).

TABLE 1

| Conditions | D50 (μm) |
|---|---|
| Bicar ®, initial | 10.5 |
| Milling 5.5 h | 4.1 |
| Milling 5.5 h | 2.4 |
| & sonication | |
| Milling 12.5 h | 1.8 |
| Milling 12.5 h | 0.85 |
| & sonication | |

### Example 1b: Preparation of the A-Side with Milling Solvent

NaHCO₃ (Bicar® from Solvay) is dispersed in Galden® HT55 by using a PENDRAULIK overhead dissolver at 3000 rpm for 1 hour to give 10 kg of a slurry containing 40 wt % NaHCO₃. The suspension is grinded by ball milling (Netzsch Zeta® RS) with ZrO₂ beads for 4 h. The particle size distribution expressed as a D50 achieved in this step is from 50 to 150 nm depending on the total milling time. The slurry is then evaporated on a rotary evaporator and the solid obtained is re-dispersed in a polyol mixture comprising 16.7 g IXOL® B251, 50.0 g Stepanol® 2412 and 33.3 g Voranol® RN 490 by using a PENDRAULIK overhead dissolver at 10000 rpm for 30 min. Afterwards other components of the A-side are added to this polyol/NaHCO₃ mixture.

### Example 2: Manufacture of Polyurethane Foams (PU Panel)

The polyol suspensions from Examples 1 and 1b are used to prepare a polyurethane foam using the components as shown in the table below:

| | | Part by |
|---|---|---|
| Compound | Type | weight |
| Stepanpol ® 3152 | Aromatic Polyester polyol | 100 |
| Trichloropropylphosphate | Flame retardant | 18.7 |
| (TCPP) | | |
| NaHCO₃ | Chemical compound | 8 |
| Methylendiphenyldiisocyanat | Isocyanate | 190 |
| (MDI) | | |

100 g of the polyol mixture prepared in example 1 and the flame retardant were stirred using a PENDRAULIK overhead dissolver in a 500 mL paper cup.

Subsequently, MDI was added and stirring continued at 2500 rpm for 10 s after which the mixture looked uniform and bubbles start to appear. After the stirrer was stopped, the mixture was poured into a 1 L paper cup to allow the foam to expand and cure for at least one day. The foam obtained can be used to prepare discontinuous panels.

### Example 3: Spray Foaming

A polyurethane foam (spray foam) was prepared by conventional means using the components as shown in the table below. The

| Type | Compound | pbw* |
|---|---|---|
| Polyester polyol | Stepanpol ® PS 2412 | 80 |
| Chemical | NaHCO₃ | 5 |
| compound | | |
| Flame retardant | TCPP | 38 |
| Surfactant | Tegostab ® B8444 | 1.5 |
| Catalyst | PMDETA | 1.5 |
| Isocyanate | Methylendiphenyldiisocyanat (MDI) | 103 |

*represents as parts per hundred of polyols by weight

### Example 4: Manufacture of Polyisocyanurate Foams (PIR Panel)

The polyol suspensions from Examples 1 and 1b are used to prepare a polyisocyanurate foam using the components as shown in the table below:

| | | Part by |
|---|---|---|
| Compound | Type | weight |
| Stepanpol ® 3152 | Aromatic Polyester polyol | 80 |
| Trichloropropylphosphate | Flame retardant | 22 |
| (TCPP) | | |
| N,N,N′,N″,N″- | Amine based catalyst | 1.5 |
| Pentamethyldiethylenetriamine | | |
| (PMDETA) | | |
| Tegostab B 8444 | Surfactant | 1.5 |
| NaHCO₃ | Chemical compound | 7.5 |
| Water | Coblowing agent | 1.5 |
| Methylendiphenyldiisocyanat | Isocyanate | 191 |
| (MDI) | | |

An MDI index of 200 was applied to prepare the polyisocyanurate foams.

80 g of the polyol mixture prepared in example 1 or 1b, the catalyst, the flame retardant and the surfactant are stirred using a PENDRAULIK overhead dissolver in a 500 mL paper cup. Subsequently, MDI is added and stirring continues at 2500 rpm for 10 s after which the mixture looks uniform and bubbles start to appear. After the stirrer was stopped, the mixture is poured into a 1 L paper cup to allow the foam to expand and cure for at least one day. The foam obtained can be used to prepare discontinuous panels.

1. A process for the preparation of a polyurethane foam or a modified polyurethane foam, the process comprising a step wherein a chemical compound releases a chemical and/or physical blowing agent by thermally- and/or chemically-induced decomposition wherein the chemical compound has a particle size distribution expressed as a D50 of equal to or less than 1 μm.

2. The process according to claim 1 wherein the chemical compound releases the chemical and/or physical blowing agent by thermally-induced decomposition.

3. The process according to claim 1 wherein the chemical compound releases the chemical and/or physical blowing agent by chemically-induced decomposition.

4. The process according to claim 1 wherein the chemical compound is an inorganic carbonate.

5. The process according to claim 1 wherein the chemical compound is a hydrate of an inorganic salt.

6. The process according to claim 1 wherein the chemical compound has a particle size distribution expressed as a D50 of equal to or above 10 nm.

7. The process according to claim 1, wherein the process comprises the steps of
a) preparing a suspension comprising the chemical compound and at least one polyol, and
b) contacting the suspension formed in step a) with a composition comprising at least one isocyanate to prepare a polyurethane foam wherein a chemical compound releases a chemical and/or physical blowing agent under thermal and/or chemical activation and wherein the chemical compound has a particle size distribution expressed as a D50 of equal to or less than 1 μm.

8. The process of claim 7, wherein the process comprises the steps of
a₁) preparing a suspension comprising the chemical compound and at least one polyol,
a₂) subjecting the suspension formed in step a₁) to a treatment to reduce the particle size distribution of the chemical compound, and
b) contacting the suspension formed in step a₂) with a composition comprising at least one isocyanate to prepare a polyurethane foam wherein a chemical compound releases a chemical and/or physical blowing agent under thermal and/or chemical activation and wherein the chemical compound has a particle size distribution expressed as a D50 of equal to or less than 1 μm.

9. The process according to claim 8 wherein the treatment to reduce the particle size distribution comprises a milling step.

10. The process according to claim 1, wherein the process comprises the steps of
m1) preparing a suspension comprising the chemical compound and a milling solvent,
m2) subjecting the suspension formed in step m1) to a treatment to reduce the particle size distribution of the chemical compound,
m3) removing the milling solvent by evaporation
m4) preparing a suspension of the chemical compound formed in step m3) in the A-side or in one or several components of the A-side, and
m5) contacting the suspension formed in step m4) with a composition comprising at least one isocyanate to prepare a polyurethane foam wherein a chemical compound releases a chemical and/or physical blowing agent under thermal and/or chemical activation and wherein the chemical compound has a particle size distribution expressed as a D50 of equal to or less than 1 μm.

11. The process according to claim 10 wherein the treatment to reduce the particle size distribution comprises a milling step.

12. A polyurethane foam or a modified polyurethane foam obtainable obtained by the process of claim 1.

13. The foam of claim 12 comprising cells with an average cell size measured according to ASTM D 3576 from 10 nm to 1 μm.

14. A composition comprising at least one polyol and a chemical compound capable of releasing a chemical and/or physical blowing agent by thermally- and/or chemically-induced degradation wherein the chemical compound has a particle size distribution expressed as a D50 of equal to or less than 1 μm.

15. (canceled)

16. The process according to claim 2 wherein the chemical compound releases the chemical and/or physical blowing agent by thermally-induced decomposition in the absence of an acidic activator.

17. The process according to claim 3 wherein the chemical compound releases the chemical and/or physical blowing agent by chemically-induced decomposition in the presence of an acidic activator.

18. The process according to claim 17 wherein the acidic activator is citric acid and/or formic acid.

19. The process according to claim 4 wherein the inorganic carbonate is NaHCO₃.

20. The process according to claim 5 wherein the hydrate of an inorganic salt is a hydrate of sodium sulphate.

21. The process according to claim 9 wherein the treatment to reduce the particle size distribution comprises a milling step using a ball mill.
